(19) United States
(12) Patent Application Publication
(10) Pub. No.: US 2022/0063586 A1
(43) Pub. Date: Mar. 3, 2022

(54) VEHICLE CONTROL SYSTEM

(71) Applicant: TOYOTA JIDOSHA KABUSHIKI KAISHA, Aichi (JP)

(72) Inventor: Yukari OKAMURA, Gotemba-shi (JP)

(21) Appl. No.: 17/407,144

(22) Filed: Aug. 19, 2021

(30) Foreign Application Priority Data
Sep. 2, 2020 (JP) 2020-147448

(51) Int. Cl. B60W 20/14; B60W 10/06; B60W 10/08; B60W 10/02

(52) U.S. Cl. CPC B60W 20/14; B60W 10/06; B60K 6/445; B60W 10/02; B60W 10/08

(57) ABSTRACT

A vehicle control system configured to achieve a required drive force and a required brake force in the process of shifting the operating mode. A first ratio is defined as a ratio of: an electric power exchanged between the first motor and a battery; to a power of a first motor to shift an operating mode. A second ratio is defined as a ratio of: an electric power exchanged between the second motor and the battery; to a power of a second motor to achieve a required power to drive or decelerate the vehicle. The first ratio is reduced smaller than the second ratio when a condition to shift the operating mode from a disconnecting mode to another mode.

### CROSS-REFERENCE TO RELATED APPLICATIONS

The present disclosure claims the benefit of Japanese Patent Application No. 2020-147448 filed on Sep. 2, 2020 with the Japanese Patent Office, the disclosures of which are incorporated herein by reference in its entirety.

### BACKGROUND

### Field of the Disclosure

Embodiments of the present disclosure relate to the art of a control system for a vehicle in which a plurality of operating modes can be selected.

### Discussion of the Related Art

For example, a structure of a hybrid vehicle is described in JP-B2-6662359, JP-A-2019-089407, and JP-A-2020-044967. The hybrid vehicles described in the above-mentioned prior art documents individually comprises: a power split mechanism that allows an engine, a first motor, and a pair of drive wheels to rotate in a differential manner; a first clutch that selectively engages a predetermined pair of rotary members of the power split mechanism; a second clutch that selectively engages a predetermined another pair of rotary members of the power split mechanism; a second motor that is connected to a torque transmission path between the power split mechanism and the drive wheels; and a brake that selectively stops a rotation of the rotary member of the power split mechanism connected to the engine.

For example, an operating mode of the hybrid vehicle of this kind may be selected from a disconnecting mode, a hybrid-low mode, and a hybrid-high mode. The disconnecting mode is established by disengaging both of the first and second clutches, and in the disconnecting mode, the hybrid vehicle is powered by the second motor while stopping the engine and the first motor. The hybrid-low mode is established by engaging the first clutch while disengaging the second clutch, and in the hybrid-low mode, a torque of the engine is delivered to the drive wheels while being multiplied by a relatively larger factor. The hybrid-high mode is established by disengaging the first clutch while engaging the second clutch, and in the hybrid-high mode, the torque of the engine is also delivered to the drive wheels. Additionally, a power of the first motor may be delivered to the drive wheels by engaging any one of the first clutch and the second clutch and the brake.

In a case of shifting the operating mode of the hybrid vehicle of this kind from the disconnecting mode, the first clutch or the second clutch is engaged after reducing a speed difference between rotary members thereof to an acceptable value by operating the first motor as a motor. By contrast, the operating mode of the hybrid vehicle of this kind is shifted to the disconnecting mode by disengaging the first clutch or the second clutch, and the first motor is operated as a generator to stop the engine 1 and the first motor promptly.

Thus, in the hybrid vehicle of this kind, the first motor is operated as a motor or generator while disengaging the first clutch and the second clutch, when shifting the operating mode. For example, when a required drive force is increased in the process of shifting the operating mode from the disconnecting mode to another mode, an electric power supplied from a battery to the second motor is increased. By contrast, when a required brake force is increased in the process of shifting the operating mode from another mode to the disconnecting mode, electricity generated by the second motor is increased.

That is, as a result of increase in the required drive force in the process of shifting the operating mode from the disconnecting mode to another mode, a required electric power to be supplied from the battery to the first motor and the second motor would exceed a maximum output power from the battery. Likewise, as a result of increase in the required brake force in the process of shifting the operating mode from another mode to the disconnecting mode, electric powers generated by reducing speeds of the first motor and the second motor would exceeds a maximum input power to the battery. In those cases, if a power consumption and a power generation of the second motor are restricted, the required drive force to propel the hybrid vehicle and the required brake force to decelerate the hybrid vehicle may not be achieved.

### SUMMARY

Aspects of embodiments of the present disclosure have been conceived noting the foregoing technical problems, and it is therefore an object of the present disclosure to provide a vehicle control system configured to achieve a required drive force and a required brake force in the process of shifting the operating mode.

The vehicle control system according to the exemplary embodiment of the present disclosure is applied to a vehicle comprising: a first motor; an engagement device that selectively interrupt torque transmission between the first motor and a pair of drive wheels; a second motor that is connected to the pair of drive wheels or another pair of drive wheels; and an electric storage device that is electrically connected with the first motor and the second motor. In the vehicle of this kind, an operating mode is shifted from a first mode to a second mode while disengaging the engagement device to interrupt the torque transmission between the first motor and the pair of drive wheels, and while changing a speed of the first motor. In order to achieve the above-explained objective, according to the exemplary embodiment of the present disclosure, the control system is provided with a controller that controls the first motor and the second motor. According to the exemplary embodiment of the present disclosure, a first ratio is defined as a ratio of: an electric power exchanged between the first motor and the electric storage device; to a power of the first motor to shift the operating mode. On the other hand, a second ratio is defined as a ratio of: an electric power exchanged between the second motor and the electric storage device; to a power of the second motor to achieve a required power to drive or decelerate the vehicle. When a condition to shift the operating mode from the first mode to the second mode is satisfied, the controller reduces the first ratio smaller than the second ratio.

In a non-limiting embodiment, the controller may be further configured to reduce the first ratio smaller than the second ratio by restricting an output power of the first motor or an electric power regenerated by the first motor.

In a non-limiting embodiment, the controller may be further configured to calculate a guard value of the output power of the first motor or the electric power regenerated by the first motor, by subtracting the electric power exchanged between the second motor and the electric storage device to achieve the required power from a maximum output power or maximum input power of the electric storage device.

In a non-limiting embodiment, the controller may be further configured to reduce the first ratio smaller than the second ratio by restricting a drive torque or regenerative torque of the first motor.

In a non-limiting embodiment, the controller may be further configured to calculate a guard value of the drive torque or regenerative torque of the first motor, by calculating an available input power or output power of the electric storage device by subtracting the electric power exchanged between the second motor and the electric storage device to achieve the required power from a maximum output power or maximum input power of the electric storage device, and dividing the available input power or output power of the electric storage device by a speed of the first motor.

In a non-limiting embodiment, the engagement device may include: a first engagement device that is engaged by connecting a predetermined pair of rotary members to establish a low mode in which a torque of the engine delivered to the pair of the drive wheels is multiplied by a relatively larger factor; and a second clutch that is engaged by connecting another pair of rotary members to establish a high mode in which the torque of the engine delivered to the pair of the drive wheels is multiplied by a factor smaller than the factor of the low mode.

In a non-limiting embodiment, the vehicle may further comprise a first differential mechanism and a second differential mechanism. Specifically, the first differential mechanism performs a differential action among: a first rotary element connected to any one of the engine, the motor, and the pair of the drive wheels; a second rotary element connected to another one of the engine, the motor, and the pair of the drive wheels; and a third rotary element. On the other hand, the second differential mechanism performs a differential action among: a fourth rotary element connected to the other one of the engine, the motor, and the pair of the drive wheels; a fifth rotary element connected to the third rotary element; and a sixth rotary element. The first engagement device selectively connects any one of a first pair of the rotary elements including the first rotary element or the second rotary element and the sixth rotary element, and a second pair of the rotary elements including any two of the fourth to sixth rotary elements. On the other hand, the second engagement device selectively connects the other one of the first pair and the second pair of the rotary elements.

As described, in the vehicle to which the control system according to the exemplary embodiment of the present disclosure is applied, the operating mode of the vehicle is shifted between the first mode and the second mode while disengaging the engagement device to interrupt the torque transmission between the first motor and the pair of drive wheels, and while changing a speed of the first motor. According to the exemplary embodiment of the present disclosure, when a condition to shift the operating mode from the first mode to the second mode is satisfied, the controller reduces the above-mentioned first ratio smaller than the above-mentioned second ratio. Specifically, an electric power to be supplied to the second motor or an electric power regenerated by the second motor is ensured on a priority basis. Therefore, when shifting the operating mode from the first mode to the second mode, the electric power can be supplied to the second motor from the electric storage device without exceeding the maximum output power of the electric storage device, and the electric power can be regenerated by the second motor without exceeding the maximum input power of the electric storage device. For this reason, a required drive force and a required brake force can be achieved certainly by the second motor when shifting the operating mode from the first mode to the second mode.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1 is a skeleton diagram schematically showing a structure of a vehicle to which the control system according to the exemplary embodiment of the present disclosure is applied;

FIG. 2 is a block diagram showing one example of a structure of the control system according to the embodiment of the present disclosure;

FIG. 3 is a nomographic diagram showing a situation in a HV-High mode;

FIG. 4 is a nomographic diagram showing a situation in a HV-Low mode;

FIG. 5 is a nomographic diagram showing a situation in a fixed mode;

FIG. 6 is a nomographic diagram showing a situation in a disconnecting mode;

FIG. 7 is a flowchart showing one example of a routine executed by the control system according to the exemplary embodiment of the present disclosure;

FIG. 8 is a flowchart showing one example a priority control of a second motor;

FIG. 9 is a time chart showing temporal changes in conditions of the hybrid vehicle during execution of the routine shown in FIG. 8; and

FIG. 10 is a flowchart showing another example of the priority control of the second motor.

### DETAILED DESCRIPTION OF THE PREFERRED EMBODIMENT(S)

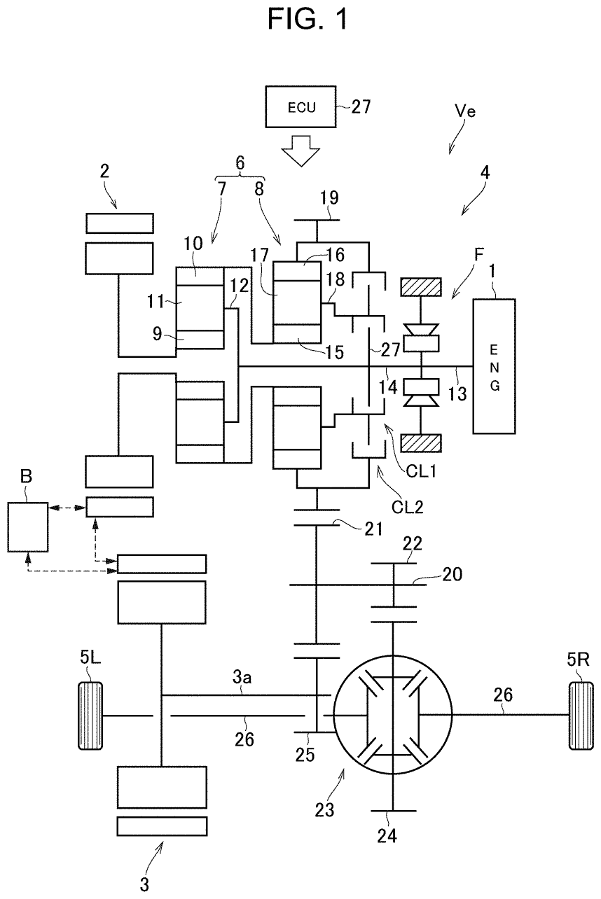

An exemplary embodiment of the present disclosure will now be explained with reference to the accompanying drawings. Referring now to FIG. 1, there is shown one example of a structure of a hybrid vehicle (as will be simply called the “vehicle” hereinafter) Ve to which the control system according to the exemplary embodiment of the present disclosure is applied. Specifically, FIG. 1 shows a hybrid drive unit (as will be simply called the “drive unit” hereinafter) 4 of the vehicle Ve that drives a pair of front wheels 5R and 5L. The drive unit 4 comprises an engine (referred to as “ENG” in the drawings) 1, a first motor (referred to as “MG1” in the drawings) 2, and a second motor (referred to as “MG2” in the drawings) 3. For example, a gasoline engine and a diesel engine may be adopted as the engine 1, and an output torque of the engine 1 is changed by controlling an intake air, a fuel injection, and an ignition timing. When the engine 1 is rotated passively while stopping a fuel supply thereto, a brake torque derived from a friction torque and a pumping loss is established by the engine 1.

According to the exemplary embodiment, a motor-generator having a generating function is adopted as the first motor 2. In the vehicle Ve, a speed of the engine 1 is controlled by the first motor 2, and the second motor 3 is driven by electric power generated by the first motor 2 to generate a drive torque for propelling the vehicle Ve. The motor-generator having a generating function may also be adopted as the second motor 3. For example, an AC motor such as a permanent magnet synchronous motor in which a magnet is arranged in a rotor may be adopted individually as the first motor 2 and the second motor 3. The first motor 2 and the second motor 3 are electrically connected with an electric storage device B as a secondary battery including a lithium-ion battery and a capacitor so that the first motor 2 and the second motor 3 may be operated individually as a motor by supplying electricity thereto from the electric storage device. Electricity generated by the first motor 2 and the second motor 3 may be accumulated in the electric storage device B. It is also possible to supply the electricity generated by one of the first motor 2 and the second motor 3 to the other one of the first motor 2 and the second motor 3.

A power split mechanism 6 as a differential mechanism is connected to the engine 1. The power split mechanism 6 includes a power split section 7 that distributes torque generated by the engine 1 to the first motor 2 side and to an output side, and a transmission section 8 that alters a torque split ratio.

For example, a single-pinion planetary gear unit adapted to perform differential action among three rotary elements may be adopted as the power split section 7. Specifically, the power split section 7 as a first differential mechanism comprises: a sun gear 9 as a first rotary element; a ring gear 10 as a third rotary element arranged concentrically around the sun gear 9; a plurality of pinion gears 11 interposed between the sun gear 9 and the ring gear 10 while being meshed with both of the gears 9 and 10; and a carrier 12 as a second rotary element supporting the pinion gears 11 in a rotatable manner.

An output shaft 13 of the engine 1 is joined to an input shaft 14 of the power split mechanism 6 connected to the carrier 12 so that the torque of the engine 1 is applied to the carrier 12, and the sun gear 9 of the power split section 7 is connected to the first motor 2. As an option, an additional gear unit (not shown) may be interposed between the input shaft 14 and the carrier 12, and a damper device and a torque converter (neither of which are shown) may be interposed between the output shaft 13 and the input shaft 14. Likewise, an additional gear unit (not shown) may also be interposed between the first motor 2 and the sun gear 9.

The transmission section 8 as a second differential mechanism is also a single-pinion planetary gear unit comprising: a sun gear 15 as a fifth rotary element; a ring gear 16 as a fourth rotary element arranged concentrically around the sun gear 15; a plurality of pinion gears 17 interposed between the sun gear 15 and the ring gear 16 while being meshed with both of the gears 15 and 16; and a carrier 18 as a sixth rotary element supporting the pinion gears 17 in a rotatable manner. Thus, the transmission section 8 is also adapted to perform a differential action among the sun gear 15, the ring gear 16, and the carrier 18. In the transmission section 8, the sun gear 15 is connected to the ring gear 10 of the power split section 7, and the ring gear 16 is connected to an output gear 19.

In order to operate the power split section 7 and the transmission section 8 as a complex planetary gear unit, a first clutch CL1 as a first engagement device is disposed to selectively connect the carrier 18 of the transmission section 8 to the carrier 12 of the power split section 7 connected to the input shaft 14. For example, a friction clutch and a dog clutch may be adopted as the first clutch CL1. Thus, in the drive unit 4 shown in FIG. 1, the power split section 7 is connected to the transmission section 8 to serve as a complex planetary gear unit by engaging the first clutch CL1. In the complex planetary gear unit thus formed, the carrier 12 of the power split section 7 is connected to the carrier 18 of the transmission section 8 to serve as an input element, the sun gear 9 of the power split section 7 serves as a reaction element, and the ring gear 16 of the transmission section 8 serves as an output element.

A second clutch CL2 as a second engagement device is arranged to rotate the rotary elements of the transmission section 8 integrally. For example, a friction clutch and a dog clutch may also be adopted as the second clutch CL2, and the second clutch CL2 selectively connects the carrier 18 to the ring gear 16 or the sun gear 15, or connects the sun gear 15 to the ring gear 16. In the drive unit 4 shown in FIG. 1, specifically, the second clutch CL2 selectively connects the carrier 18 to the ring gear 16 to rotate the rotary elements of the transmission section 8 integrally. In a case that the second clutch CL2 is in engagement, the carrier 12 of the power split section 7 also serves as an input element, the sun gear 9 of the power split section 7 also serves as a reaction element, and the ring gear 16 of the transmission section 8 also serves as an output element.

In the drive unit 4 shown in FIG. 1, accordingly, the rotary members of the power split mechanism 6 and the rotary members rotated integrally therewith serve as “a plurality of rotary members” of the embodiment, a pair of the carrier 12 (including rotary members rotated integrally therewith) and the carrier 18 or a pair of the ring gear 16 (including rotary members rotated integrally therewith) and the carrier 18 serves as “a pair of rotary members” of the embodiment, and the first clutch CL1 and the second clutch CL2 serve as “an engagement device” of the embodiment.

The engine 1 is connected to the output gear 19 though the power split mechanism 6 by engaging at least one of the first clutch CL1 and the second clutch CL2. Consequently, an output torque of the engine 1 is distributed to the front wheels 5R and 5L via the output gear 19 and a geartrain. To this end, specifically, a counter shaft 20 extends parallel to a common rotational axis of the engine 1, the power split section 7, and the transmission section 8. A driven gear 21 is fitted onto one end of the counter shaft 20 to be meshed with the output gear 19, and a drive gear 22 is fitted onto the other end of the counter shaft 20 to be meshed with a ring gear 24 of a differential gear unit 23 as a final reduction.

The driven gear 21 is also meshed with a drive gear 25 fitted onto a rotor shaft 3a of the second motor 3 so that an output torque of the second motor 3 is synthesized with torque of the output gear 19 at the driven gear 21 to be distributed from the differential gear unit 23 to the front wheels 5R and 5L via each drive shafts 26. Instead, the second motor 3 may also be connected to other rotary member arranged between the output gear 19 and the front wheels 5R, 5L such as the drive gear 22.

In order to deliver a drive torque generated by the first motor 2 to the front wheels 5R and 5L, a one-way clutch F is arranged in the drive unit 4. Specifically, the one-way clutch F is disposed downstream of the engine 1 to prevent a counterrotation of the output shaft 13 of the engine 1 connected to the input shaft 14 of the power split mechanism 6 during operation of the engine 1.

That is, the one-way clutch F is engaged by generating the drive torque by the first motor 2. In this situation, the one-way clutch F establishes a reaction torque against the drive torque generated by the first motor 2 so that the drive torque generated by the first motor 2 is delivered to the ring gear 16 of the transmission section 8. That is, a rotation of the output shaft 13 connected to the input shaft 14 is stopped by the one-way clutch F. Consequently, the carrier 12 of the power split section 7 and the carrier 18 of the transmission section 8 serve as a reaction element, and the sun gear 9 of the power split section 7 serves as an input element.

In order to establish a reaction torque against the drive torque generated by the first motor 2, a friction brake may also be employed to stop the rotation of the output shaft 13 or the input shaft 14 instead of the one-way clutch F. In this case, the friction brake may be adapted to stop the rotation of the output shaft 13 or the input shaft 14 not only completely but also incompletely by applying a reaction torque to those shafts.

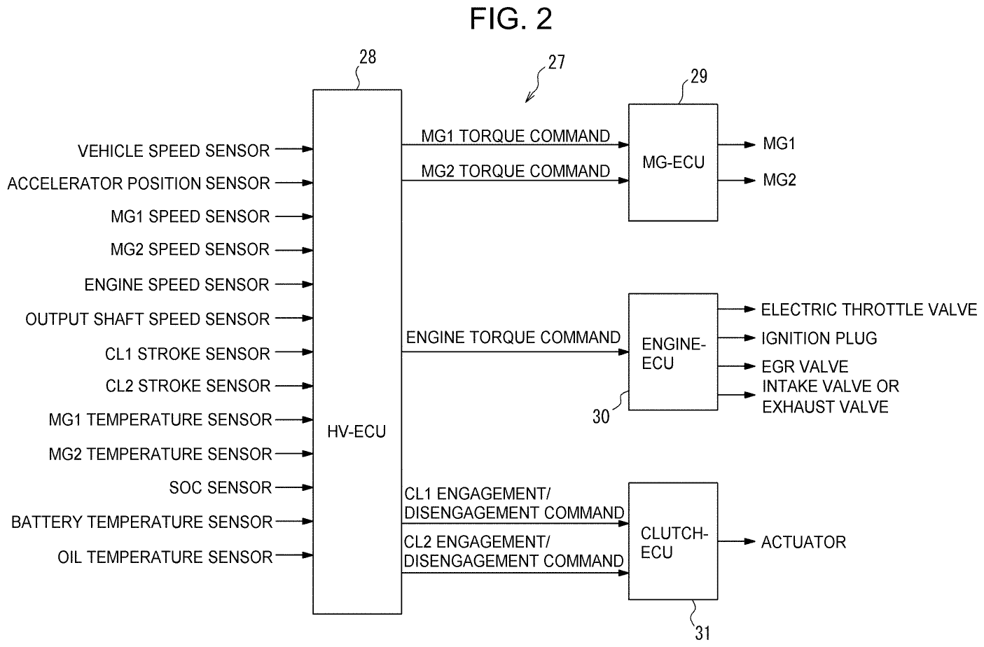

The vehicle Ve is controlled by an electronic control unit (to be abbreviated as the “ECU” hereinafter) 27 as a controller comprising a microcomputer as its main constituent. A structure of the ECU 27 is shown in FIG. 2 in detail. Specifically, as shown in FIG. 2, the ECU 27 comprises a hybrid control unit (as will be called the “HV-ECU” hereinafter) 28, a motor control unit (as will be called the “MG-ECU” hereinafter) 29, an engine control unit (as will be called the “engine-ECU” hereinafter) 30, and a clutch control unit (as will be called the “clutch-ECU” hereinafter) 31.

The HV-ECU 28 transmits command signals to the MG-ECU 29, the engine-ECU 30, and the clutch-ECU 31 based on incident data transmitted from various sensors, and maps and formulas installed in advance. For example, the HV-ECU 28 receives data about; a vehicle speed; an accelerator position; a speed of the first motor 2; a speed of the second motor 3; a speed of the output shaft 13 of the engine 1; an output speed such as a rotational speed of the counter shaft 20 of the transmission section 8; a stroke of e.g., a piston of the first CL1; a stroke of e.g., a piston of the second clutch CL1; a temperature of the first motor 2; a temperature of the second motor 3; a state of charge (SOC) level of the electric storage device B; a temperature of the electric storage device B; a temperature of oil (ATF) for cooling and lubricating members of the drive unit 4, and so on.

Specifically, based on the above-mentioned data sent to the HV-ECU 28, the HV-ECU 28 calculates output torques of the first motor 2 and the second motor 3, and transmits calculation results to the MG-ECU 29 in the form of command signal. Likewise, the HV-ECU 28 calculates output torque of the engine 1, and transmits calculation results to the engine-ECU 30 in the form of command signal. In addition, the HV-ECU 28 determines engagement and disengagement of the first clutch CL1 and the second clutch CL2 based on the above-mentioned data sent to the HV-ECU 28, and transmits command signals to engage and disengage the first clutch CL1 and the second clutch CL2 to the clutch-ECU 31. Given that the friction clutch is employed as the above-mentioned engagement devices, the HV-ECU 28 also determines required torque transmitting capacities of the first clutch CL1 and the second clutch CL2, and transmits command signals to achieve the required torque transmitting capacities of the first clutch CL1 and the second clutch CL2 to the clutch-ECU 31.

The MG-ECU 29 calculates current values applied to the first motor 2 and the second motor 3 based on the data transmitted from the HV-ECU 28, and transmits calculation results to the first motor 2 and the second motor 3 in the form of command signals. In the vehicle Ve, an AC motor is adopted as the first motor 2 and the second motor 3, respectively. Therefore, in order to control the AC motor, the command signal transmitted from the MG-ECU 29 includes command signals for controlling a frequency of a current generated by the inverter and a voltage value boosted by the converter.

The engine ECU 30 calculates current values to control opening degrees of an electronic throttle valve, an EGR (Exhaust Gas Restriction) valve, an intake valve, an exhaust valve, and an exhaust valve, and to activate an ignition plug, based on the data transmitted from the HV-ECU 28. Calculation results are transmitted from the engine ECU 30 to the valves and the plug in the form of command signals. Thus, the engine ECU 30 transmits command signals for controlling a power, an output torque, and a speed of the engine 1.

The clutch ECU 31 calculates control amounts of actuators (not shown) of the first clutch CL1 and the second clutch CL2 to engage or disengage the first clutch CL1 and the second clutch CL2, based on the command signal transmitted from the HV-ECU 28. Optionally, the engine 1, the first motor 2, the second motor 3, the first clutch CL1, and the second clutch CL2 may be controlled by dedicated controllers.

In the vehicle Ve, an operating mode may be selected from a hybrid mode (to be abbreviated as the “HV mode” hereinafter) in which the vehicle Ve is propelled by a drive torque generated by the engine 1, and an electric vehicle mode (to be abbreviated as the “EV mode” hereinafter) in which the vehicle Ve is propelled by drive torques generated by the first motor 2 and the second motor 3 without activating the engine 1. The HV mode may be selected from a hybrid-low mode (to be abbreviated as the “HV-Low mode” hereinafter), a hybrid-high mode (to be abbreviated as the “HV-High mode” hereinafter), and a fixed mode. Specifically, in the HV-Low mode, torque delivered to the ring gear 16 of the transmission section 8 (or the output gear 19) by generating a predetermined torque by the engine 1 is relatively large. By contrast, in the HV-High mode, the torque delivered to the ring gear 16 of the transmission section 8 by generating the predetermined torque by the engine 1 is relatively small. In the fixed mode, the torque generated by the engine 1 is delivered to the ring gear 16 of the transmission section 8 without being changed.

The EV mode may be selected from a dual-motor mode in which both of the first motor 2 and the second motor 3 generate drive torques to propel the vehicle Ve, and a single-motor mode in which only the second motor 3 generates a drive torque to propel the vehicle Ve. Further, the dual-motor mode may be selected from an electric vehicle-low mode (to be abbreviated as the “EV-Low mode” hereinafter) in which a torque of the first motor 2 is multiplied by a relatively larger factor, and an electric vehicle-high mode (to be abbreviated as the “EV-High mode” hereinafter) in which a torque of the first motor 2 is multiplied by a relatively smaller factor. In the single-motor mode, the vehicle Ve may be propelled while engaging both of the first clutch CL1 and the second clutch CL2, while disengaging both of the first clutch CL1 and the second clutch CL2, or while engaging only the second clutch CL2. In the following explanation, the single-motor mode in which the vehicle Ve is powered only by the second motor 3 while disengaging both of the first clutch CL1 and the second clutch CL2 will be called the “disconnecting mode”.

Table 1 shows engagement states of the first clutch CL1, the second clutch CL2, and the one-way clutch F, and operating conditions of the first motor 2, the second motor 3, and the engine 1 in each operating mode. In Table 1, “ [symbol] ” represents that the engagement device is in engagement, “−” represents the engagement device is in disengagement, “G” represents that the motor serves mainly as a generator, “M” represents that the motor serves mainly as a motor, blank represents that the motor serves as neither a motor nor a generator or that the motor is not involved in propulsion of the vehicle Ve, “ON” represents that the engine 1 generates a drive torque, and “OFF” represents that the engine 1 does not generate a drive torque.

TABLE 1

| Operating Mode | | | CL1 | CL2 | F | MG1 | MG2 | ENG |
|---|---|---|---|---|---|---|---|---|
| HV | HV-LOW | | [symbol] | | | G | M | ON |
| MODE | HV-HIGH | | | [symbol] | | G | M | ON |
| | FIXED | | [symbol] | [symbol] | | | | ON |
| EV | DUAL- | EV- | [symbol] | | [symbol] | M | M | OFF |
| MODE | MOTOR | LOW | | | | | | |
| | | EV- | | [symbol] | [symbol] | M | M | OFF |
| | | HIGH | | | | | | |

| | | | | | |
|---|---|---|---|---|---|
| SINGLE-MOTOR | — | — | — | M | OFF |

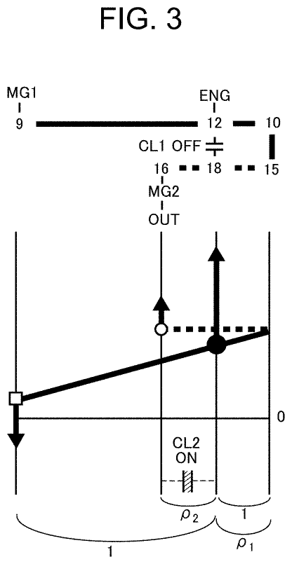

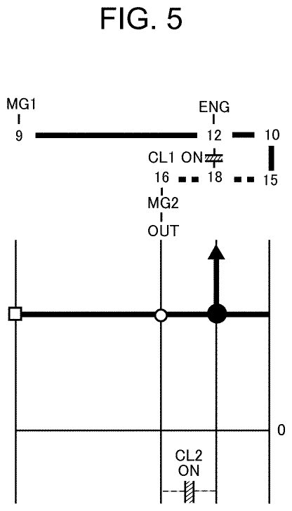

Rotational speeds of the rotary elements of the power split mechanism 6, and directions of torques of the engine 1, the first motor 2, and the second motor 3 in the HV-High mode, the HV-Low mode, the fixed mode, and the disconnecting mode are indicated in FIGS. 3 to 6. In the nomographic diagrams shown in FIGS. 3 to 6, distances among the vertical lines represents a gear ratio of the power split mechanism 6, a vertical distance on the vertical line from the horizontal base line represents a rotational speed, an orientation of the arrow represents a direction of the torque, and a length of the arrow represents a magnitude of the torque.

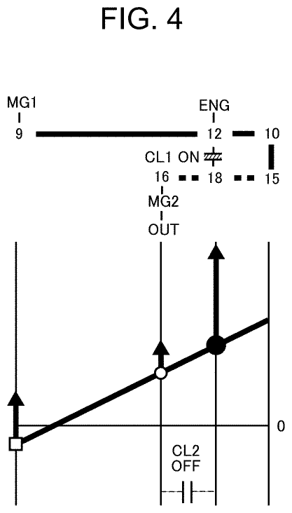

As indicated in FIG. 3, in the HV-High mode, the second clutch CL2 is engaged, and the vehicle Ve is propelled by a drive torque generated by the engine 1 while establishing a reaction torque by the first motor 2. As indicated in FIG. 4, in the HV-Low mode, the first clutch CL1 is engaged, and the vehicle Ve is propelled by a drive torque generated by the engine 1 while establishing a reaction torque by the first motor 2.

A magnitude of the torque delivered from the engine 1 to the ring gear 16 differs between the HV-High mode and the HV-Low mode. Specifically, given that an output torque of the engine 1 is Te, a magnitude of the torque delivered to the ring gear 16 in the HV-Low mode may be expressed as “(1/(−ρ1·ρ2))Te”, and a magnitude of the torque delivered to the ring gear 16 in the HV-High mode may be expressed as “(1/(1+ρ1))Te”. In the above-expressed expressions, “ρ1” is a gear ratio of the power split section 7 (i.e., a ratio between teeth number of the ring gear 10 and teeth number of the sun gear 9), and “ρ2” is a gear ratio of the transmission section 8 (i.e., a ratio between teeth number of the ring gear 16 and teeth number of the sun gear 15). Here, it is to be noted that “ρ1” and “ρ2” are smaller than 1, respectively.

Thus, the torque delivered from the engine 1 to the ring gear 16 (or the front wheels 5R and 5L) in the HV-Low mode is multiplied by a larger factor than in the HV-High mode. Accordingly, in the exemplary embodiment of the present disclosure, the carrier 12 and the carrier 18 serves as “a predetermined pair of rotary members” or “a first pair of rotary elements”, and the ring gear 16 and the carrier 18 serves as “another pair of rotary members” or “a second pair of rotary elements”.

If the first motor 2 generates a torque greater than the above-explained reaction torque in the HV mode, a speed of the engine 1 is reduced by the torque of the first motor 2 increased from the reaction torque. By contrast, if the first motor 2 generates a torque smaller than the above-explained reaction torque in the HV mode, a speed of the engine 1 is increased by a part of torque generated by the engine 1. That is, in the HV mode, a speed of the engine 1 can be controlled by controlling the torque of the first motor 2. Specifically, in the HV mode, the torque of the first motor 2 is controlled in such a manner as to adjust the speed of the engine 1 to a target speed at which a total energy efficiency in the vehicle Ve including a fuel efficiency of the engine 1 and a driving efficiency of the first motor 2 are optimized. The total energy efficiency in the vehicle Ve may be calculated by dividing a total energy consumption by a power to rotate the front wheels 5R and 5L.

As a result of establishing a reaction torque by the first motor 2, the first motor 2 serves as a generator. In this situation, a power of the engine 1 is partially translated into an electric power by the first motor 2, and the remaining power of the engine 1 is delivered to the ring gear 16 of the transmission section 8. The electric power thus translated by the first motor 2 may not be only supplied to the second motor 3 to operate the second motor 3 but also accumulated in the electric storage device B to raise a state of charge level of the electric storage device B.

In the fixed mode, both of the first clutch CL1 and the second clutch CL2 are engaged so that all of the rotary elements in the power split mechanism 6 are rotated at a same speed. That is, a differential rotation between the engine 1 and the output gear 19 is restricted. In the fixed mode, specifically, the output power of the engine 1 will not be translated into an electric energy by the first motor 2 and the second motor 3, and delivered entirely to the front wheels 5R and 5L through the power split mechanism 6. For this reason, a power loss such as a Joule loss associated with such energy conversion will not be caused in the fixed mode and hence power transmission efficiency can be improved.

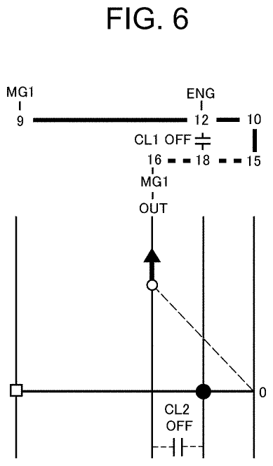

The disconnecting mode is established by disengaging both of the first clutch CL1 and the second clutch CL2 so that torque transmission between the engine 1 and the front wheels 5R and 5L is interrupted. Accordingly, as indicated in FIG. 6, the engine 1 and the first motor 2 are stopped in the disconnecting mode. In this situation, rotations of the rotary elements of the power split section 7 and the sun gear 15 of the transmission section 8 are stopped, the ring gear 16 is rotated at a speed corresponding to a speed of the vehicle Ve, and the carrier 18 is rotated at a speed governed by the gear ratio of the transmission section 8 and the speed of the ring gear 16. For example, in the disconnecting mode, the engine 1 may be activated to be warmed. However, since both of the first clutch CL1 and the second clutch CL2 are disengaged, a torque of the engine 1 will not be delivered to the front wheels 5R and 5L.

When shifting the operating mode from the disconnecting mode to another mode, first of all, a speed difference between the carrier 18 and the carrier 12 or the ring gear 16 is reduced to a predetermined value by controlling a speed of the first motor 2. In this situation, since both of the first clutch CL1 and the second clutch CL2 are disengaged, a torque generated by the first motor 2 to change the speed of the first motor 2 will not be delivered to the front wheels 5R, and 5L. Thereafter, one of the first clutch CL1 and second clutch CL2 is engaged. That is, in a case of shifting the operating mode from the disconnecting mode to the fixed mode, the operating mode is shifted from the disconnecting mode to the fixed mode via the HV-Low mode or HV-High mode.

Inversely, when shifting the operating mode from the mode in which one of the first clutch CL1 and second clutch CL2 is engaged to the disconnecting mode, the first clutch CL1 or the second clutch CL2 being engaged is disengaged. Thereafter, a speed of the first motor is controlled in such a manner as to promptly stop the engine 1 and the first motor 2. In this situation, since both of the first clutch CL1 and the second clutch CL2 are disengaged, a torque generated by the first motor 2 will also not be delivered to the front wheels 5R and 5L.

In the case of changing a speed of the first motor 2 while disengaging both of the first clutch CL1 and second clutch CL2, a torque control and a speed control of the first motor 2 are executed independent of a torque control of the second motor 3.

As described, the first motor and the second motor 3 are connected to the electric storage device B, respectively. Therefore, if the first motor 2 and the second motor 3 are controlled separately, a total electric power supplied from the electric storage device B to the first motor 2 and the second motor 3 would exceed a maximum output power Wout of the electric storage device B, and a total electric power generated by the first motor 2 and the second motor 3 would exceed a maximum input power Win of the electric storage device B.

By contrast, if the first motor 2 is controlled to stop the engine 1 when shifting the operating mode from the HV-Low mode to the EV-Low mode or from the HV-High mode to the EV-High mode, a torque derived from an inertia torque of the engine 1 will be delivered to the front wheels 5R and 5L. In this situation, therefore, the torque of the second motor 3 is controlled based on the inertia torque. Inversely, when shifting the operating mode from the EV-Low mode to the HV-Low mode or from the EV-High mode to the HV-High mode, a speed of the engine 1 is increased to a starting speed by controlling a speed of the first motor 2, and then the fuel is supplied to the engine 1. In this situation, the inertia torque of the engine 1 acts as a reaction torque so that a torque derived from an inertia torque of the engine 1 will be delivered to the front wheels 5R and 5L. Therefore, the torque of the second motor 3 is controlled based on the inertia torque also in this situation. Specifically, the torque of the second motor 3 is controlled taking account of an energy corresponding to an electric power supplied to the first motor 2 and an energy corresponding to an electric power generated by the first motor 2. That is, the torque of the first motor 2 and the torque of the second motor 3 are controlled cooperatively.

For example, in a case of shifting the operating mode from the EV-High mode to the HV-High mode, the first motor 2 is operated as a generator so as to increase a speed of the engine 1. Consequently, a torque of the first motor 2 corresponding to the inertia torque of the engine 1 is applied as a brake torque to the front wheels 5R and 5L. In this case, if the vehicle Ve is decelerated while increasing the speed of the engine 1, the second motor 3 will generate a torque corresponding to a difference between a required brake torque and the brake torque applied from the first motor 2 to the front wheels 5R and 5L. In this situation, therefore, the torque of the first motor 2 and the torque of the second motor 3 are controlled cooperatively so that a total electric power generated by the first motor 2 and the second motor 3 will not exceed the maximum input power Win of the electric storage device B.

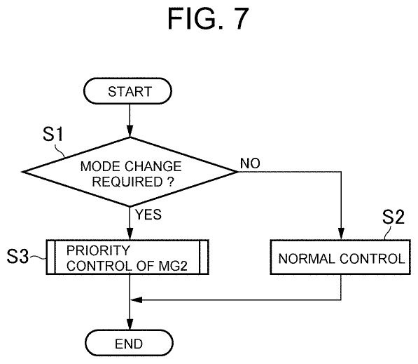

According to the exemplary embodiment of the present disclosure, the vehicle control system is configured to achieve a required drive force and a required brake force without exceeding the maximum output power Wout and the maximum input power Win of the electric storage device B, when changing a speed of the first motor 2 while disengaging both of the first clutch CL1 and the second clutch CL2. To this end, the vehicle control system executes a routine shown in FIG. 7.

At step S1, it is determined whether it is required to shift the operating mode to/from the disconnecting mode while disengaging both of the first clutch CL1 and the second clutch CL2 and while changing a speed of the first motor 2. In other words, at step S1, it is determined whether it is required to shift the operating mode between the disconnecting mode (also referred to as the “first mode”) and another mode (also referred to as the “second mode”). For example, such determination at step S1 may be made based on a position of an accelerator pedal representing a required drive force detected by an accelerator sensor and a speed of the vehicle Ve detected by a vehicle speed sensor (neither of which are shown), with reference to a map for selecting the operating mode based on the required drive force and the speed of the vehicle Ve which is installed in the ECU 27. Instead, such determination at step S1 may be also made based on a shifting command transmitted by another kind of control.

If the mode change between the first mode and the second mode is not required so that the answer of step S1 is NO, the routine progresses to step S2 to maintain the current operating mode. In this case, the operating mode is controlled by the normal control.

By contrast, if the mode change between the first mode and the second mode is required so that the answer of step S1 is YES, the routine progresses to step S3 to execute a priority control of the second motor 3. At step S3, specifically, operating points (or torques) of the first motor 2 and the second motor 3 are set in such a manner as to supply an electric power to the second motor 3 or to regenerate electric power by the second motor 3 on a priority basis over the first motor 2. Thereafter, the routine returns.

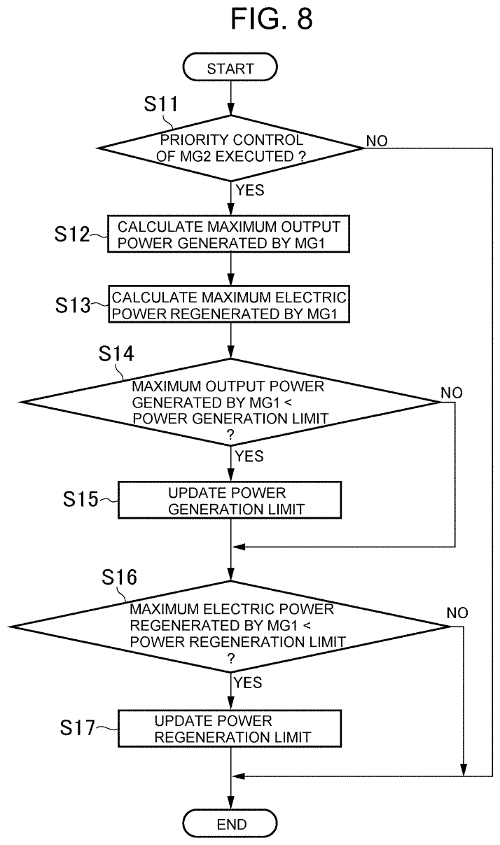

Turning to FIG. 8, there is shown one example of a subroutine executed at step S3. At step S11, it is determined whether an execution flag of the priority control of the second motor 3 is on. That is, at step S11, it is determined whether the priority control of the second motor 3 was commenced at step S3.

If the execution flag of the priority control of the second motor 3 is off so that the answer of step S11 is NO, the routine returns. By contrast, if the execution flag of the priority control of the second motor 3 is on so that the answer of step S11 is YES, the routine progresses to step S12 to calculate a maximum output power of the first motor 2 to be generated by supplying an excess power of the electric storage device B to the first motor 2. Specifically, such maximum output power of the first motor 2 may be calculated by subtracting an electric power to be supplied from the electric storage device B to the second motor 3 to achieve a required drive force, from the maximum output power Wout of the electric storage device B.

For example, the maximum output power Wout of the electric storage device B may be calculated based on a temperature and an SOC level of the electric storage device B. On the other hand, the electric power to be supplied to the second motor 3 may be calculated by multiplying a required drive torque of the second motor 3 by a speed of the second motor 3.

During execution of the required mode change operation while disengaging both of the first clutch CL1 and the second clutch CL2, there may be a case where the first motor 2 is operated as a generator. At step S13, therefore, a maximum electric power to be regenerated by the first motor 2 which can be stored in the electric storage device B is calculated. Specifically, such maximum electric power to be regenerated by the first motor 2 which can be stored in the electric storage device B may be calculated by subtracting an electric power to be regenerated by the second motor 3 by controlling a torque of the second motor 3 to achieve a required brake force from the maximum input power Win of the electric storage device B. That is, an electric power to be regenerated by the first motor 2 corresponding to a current available capacity of the electric storage device B is calculated at step S13.

For example, the maximum input power Win of the electric storage device B may also be calculated based on a temperature and an SOC level of the electric storage device B. On the other hand, the electric power to be regenerated by the second motor 3 may be calculated by multiplying a required brake torque of the second motor 3 by a speed of the second motor 3.

Then, it is determined at step S14 whether the maximum output power to be generated by the first motor 2 calculated at step S12 is smaller than a current power generation limit of the first motor 2. As explained later, the power generation limit of the first motor 2 will be updated at step S15 to the maximum output power calculated at step S12. If the current routine is the first routine and hence step S15 has not yet been executed, a rated output of the electric storage device B may be employed as the power generation limit of the first motor 2. For example, a maximum drive torque generated by the first motor 2 is reduced depending on a temperature of the first motor 2. Therefore, the power generation limit of the first motor 2 may be set taking account of a temperature of the first motor.

If the maximum output power to be generated by the first motor 2 calculated at step S12 is smaller than the current power generation limit of the first motor 2 so that the answer of step S14 is YES, the routine progresses to step S15 to update the power generation limit of the first motor 2 to the maximum output power calculated at step S12. Then, the routine progresses to after-mentioned step S16.

By contrast, if the maximum output power to be generated by the first motor 2 calculated at step S12 is greater than the current power generation limit of the first motor 2 so that the answer of step S14 is NO, the routine also progresses to step S16. At step S16, it is determined whether the maximum electric power to be regenerated by the first motor 2 calculated at step S13 is smaller than a current power regeneration limit of the first motor 2. As explained later, the power regeneration limit of the first motor 2 will be updated at step S17 to the maximum electric power calculated at step S13. If the current routine is the first routine and hence step S17 has not yet been executed, a rated output of the electric storage device B may also be employed as the power regeneration limit of the first motor 2. For example, a maximum regenerative torque generated by the first motor 2 is reduced depending on a temperature of the first motor 2. Therefore, the power regeneration limit of the first motor 2 may be set taking account of a temperature of the first motor 2.

Given that the first motor 2 is operated as a motor, the power generated by the first motor 2 may be expressed as a positive value. By contrast, given that the first motor 2 is operated as a generator, the electric power regenerated by the first motor 2 may be expressed as a negative value.

If the maximum electric power to be regenerated by the first motor 2 calculated at step S13 is smaller than the current power regeneration limit of the first motor 2 so that the answer of step S16 is YES, the routine progresses to step S17 to update the power regeneration limit of the first motor 2 to the maximum electric power calculated at step S13. Thereafter, the routine returns. By contrast, if the maximum electric power to be regenerated by the first motor 2 calculated at step S13 is greater than the current power regeneration limit of the first motor 2 so that the answer of step S16 is NO, the routine returns. In this case, the current power regeneration limit is maintained.

Thus, in the case of shifting the operating mode between the first mode and the second mode while changing a speed of the first motor 2, the second motor is controlled on a priority basis to achieve the required power to drive or decelerate the vehicle Ve. Specifically, a second ratio of: the electric power exchanged between the second motor 3 and the electric storage device B; to a power of the second motor 3 to achieve the required power to drive or decelerate the vehicle Ve, is maintained to 100 percent. On the other hand, a first ratio of: the electric power exchanged between the first motor 2 and the electric storage device B; to a power of the first motor 2 to shift the operating mode, is reduced smaller than the second ratio.

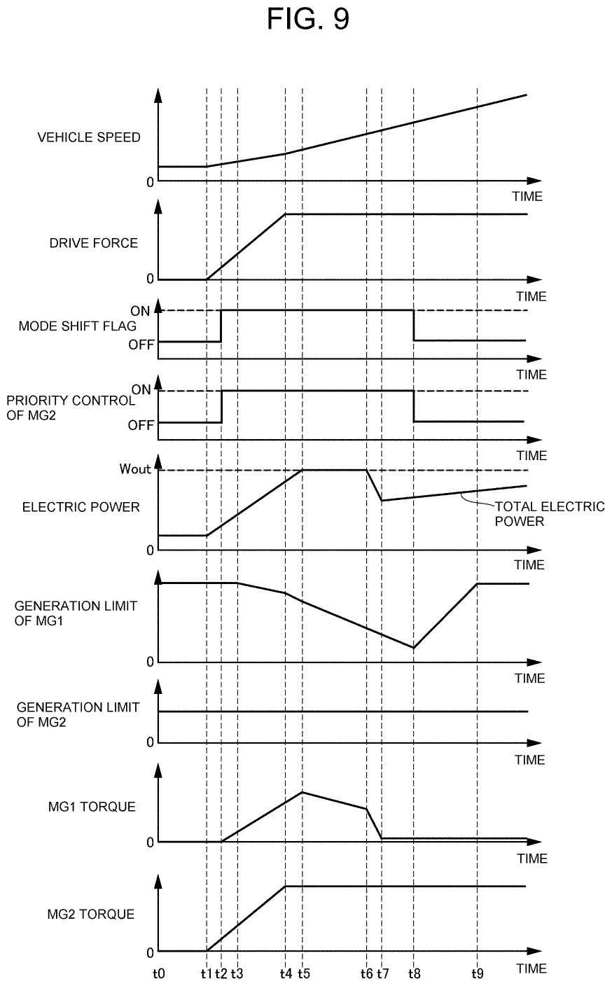

Turning to FIG. 9, there is shown one example of a temporal change in the power generation limit of the first motor 2 during execution of the priority control of the second motor 3 in the case of shifting the operating mode from the disconnecting mode to the HV-Low mode or HV-High mode.

At point to, the vehicle Ve travels at a constant speed in the disconnecting mode. In this situation, therefore, the priority control of the second motor 3 has not yet commenced, and the power generation limit of the first motor 2 is maintained to a predetermined value which is set based on e.g., a rated output of the electric storage device B.

At point t1, the accelerator pedal is depressed so that a required drive force is increased. In this situation, therefore, an output torque and an output power of the second motor 3 are increased with an increase in the required drive force. Consequently, a speed of the vehicle Ve starts increasing from point t1. Then, at point t2, a condition to shift the operating mode from the disconnecting mode to the HV-Low mode or HV-High mode is satisfied so that the execution flag of the priority control of the second motor 3 is turned on. Consequently, the routine shown in FIG. 8 progresses from step S11 to step S12.

In this situation, the vehicle Ve travels at a relatively low speed and the required drive force is relatively small, therefore, the output power of the second motor 3 is relatively small. At point t2, therefore, the maximum output power of the first motor 2 calculated at step S12 is greater than the power generation limit of the first motor 2, and hence the answer of step S14 of the routine shown in FIG. 8 is still NO. That is, at point t2, the power generation limit of the first motor 2 is still maintained to the predetermined value. At the same time, in order to reduce a speed difference in the first clutch CL1 or the second clutch CL2 to be engaged to establish the HV-Low mode or the HV High mode, the output torque (i.e., the drive torque) of the first motor 2 is increased gradually from point t2.

The output power of the second motor 3 is increased with increases in the required drive force and the speed of the vehicle Ve, and consequently the maximum output power of the first motor 2 calculated at step S12 falls below the power generation limit of the first motor 2 at point t3. At point t3, therefore, the routine shown in FIG. 8 progresses from step S14 to step S15 to update the power generation limit of the first motor 2. That is, the power generation limit of the first motor 2 is reduced gradually from point t3. In this situation, the output power required to be generated by the first motor 2 is smaller than the updated power generation limit of the first motor 2. Therefore, at point t3, a total value of an electric power supplied from the electric storage device B to the first motor 2 and an electric power supplied from the electric storage device B to the second motor 3 is smaller than the maximum output power Wout of the electric storage device B.

At point t4, the required drive force becomes constant, and hence the output torque of the second motor 3 is maintained to a constant value from point t4. In this situation, the speed of the vehicle Ve is increasing continuously, and the output power of the second motor 3 is increased in proportion to the increase in the speed of the vehicle Ve. Consequently, the power generation limit of the first motor 2 is being reduced continuously in this situation.

At point t5, the output power of the first motor 2 is increased to the power generation limit of the first motor 2. In this situation, the power generation limit of the first motor 2 is still being reduced with the increase in the output power of the second motor 3, therefore, the output power of the first motor 2 is reduced from point t5. Consequently, the total value of an electric power supplied from the electric storage device B matches with the maximum output power Wout from point t5. In this situation, a change rate of the speed of the first motor 2 is reduced by reducing the output power of the first motor 2 so that a period of time to reduce the speed difference in the first clutch CL1 or the second clutch CL2 is extended.

At point t6, since the speed difference in the first clutch CL1 or the second clutch CL2 has been reduced to the predetermined value, the output torque of the first motor 2 is further reduced from point t6. Eventually, at point t7, the speed difference in the first clutch CL1 or the second clutch CL2 is reduced to a speed at which the first clutch CL1 or the second clutch CL2 can be engaged. Consequently, an engagement of the first clutch CL1 or the second clutch CL2 is commenced at point t7.

The engagement of the first clutch CL1 or the second clutch CL2 is completed at point t8 so that the execution flag of the priority control of the second motor 3 is turned off. Consequently, the power generation limit of the first motor 2 is increased gradually to the power generation limit of the normal condition from point t8 to point t9.

By thus executing the priority control of the second motor 3, the power generation limit of the first motor 2 is set to the value calculated by subtracting the electric power supplied to the second motor 3 from the maximum output power Wout of the electric storage device B. That is, the output torque of the second motor 3 is set prior to setting the output torque of the first motor 2 so that the electric power can be supplied to the second motor 3 from the electric storage device B on a priority basis without exceeding the maximum output power Wout. For this reason, the output torque of the second motor 3 will not be restricted during the shifting operation from the disconnecting mode. In other words, the required drive force can be achieved certainly during the shifting operation from the disconnecting mode.

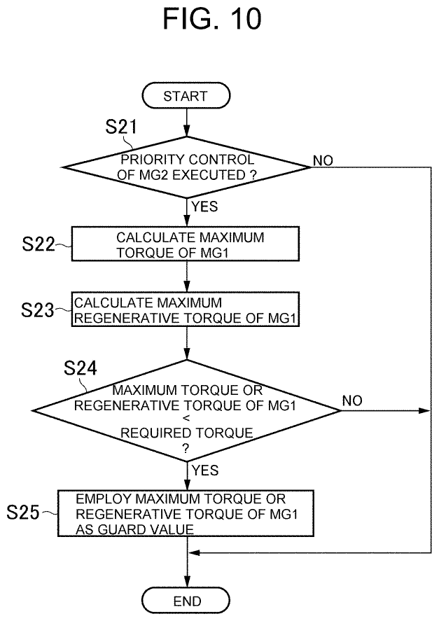

Turing to FIG. 10, there is shown another example of the priority control of the second motor 3 in which a drive torque or a regenerative torque of the first motor 2 is restricted.

At step S21, it is determined whether the execution flag of the priority control of the second motor 3 is on. That is, at step S21, it is determined whether the priority control of the second motor 3 was commenced at step S3 of the routine shown in FIG. 7.

If the execution flag of the priority control of the second motor 3 is off so that the answer of step S21 is NO, the routine returns. By contrast, if the execution flag of the priority control of the second motor 3 is on so that the answer of step S21 is YES, the routine progresses to step S22 to calculate a maximum torque of the first motor 2 to be generated by supplying an excess power of the electric storage device B to the first motor 2. In order to calculate such maximum torque of the first motor 2, an available electric power of the electric storage device B which can be supplied to the first motor 2 is calculated by subtracting: an electric power to be supplied from the electric storage device B to the second motor 3 to achieve a required drive force; from the maximum output power Wout of the electric storage device B. Then, the maximum torque of the first motor 2 is calculated by dividing the available electric power of the electric storage device B by an absolute value of a current speed of the first motor 2.

During execution of the required mode change operation while disengaging both of the first clutch CL1 and the second clutch CL2, there may be a case where the first motor 2 is operated as a generator. At step S23, therefore, a maximum regenerative torque of the first motor 2 at which a resultant electric power can be stored in the electric storage device B is calculated. In order to calculate such maximum regenerative torque of the first motor 2, a maximum electric power which can be stored in the electric storage device B is calculated by subtracting: an electric power to be regenerated by the second motor 3 by controlling a torque of the second motor 3 to achieve a required brake force; from the maximum input power Win of the electric storage device B. Then, the maximum regenerative torque of the first motor 2 is calculated by dividing the maximum electric power which can be stored in the electric storage device B by an absolute value of a current speed of the first motor 2. That is, a regenerative torque of the first motor 2 corresponding to an available capacity of the electric storage device B is calculated at step S23.

Then, it is determined a step S24 whether the maximum torque or maximum regenerative torque of the first motor 2 is smaller than a required torque to be generated by the first motor 2. In other words, it is determined a step S24 whether the required torque to be generated by the first motor 2 is greater than the maximum torque or maximum regenerative torque of the first motor 2.

If the required torque to be generated by the first motor 2 is greater than the maximum torque or maximum regenerative torque of the first motor 2 so that the answer of step S24 is YES, the routine progresses to step S25 to restrict the required torque to be generated by the first motor 2 to the maximum torque or maximum regenerative torque of the first motor 2. Thereafter, the routine returns. That is, the maximum torque or maximum regenerative torque of the first motor 2 is employed as a guard value of the required torque to be generated by the first motor 2.

By contrast, if the required torque to be generated by the first motor 2 is smaller than the maximum torque or maximum regenerative torque of the first motor 2 so that the answer of step S24 is NO, the routine returns. In this case, the first motor 2 is operated to generates the required torque.

As described, in the case of shifting the operating mode between the first mode and the second mode while changing a speed of the first motor 2, the second motor is controlled on a priority basis to achieve the required power to drive or decelerate the vehicle Ve. Specifically, the second ratio of: the electric power exchanged between the second motor 3 and the electric storage device B; to a drive power or regenerative power of the second motor 3 to achieve the required power to drive or decelerate the vehicle Ve, is maintained to 100 percent. On the other hand, the first ratio of: the electric power exchanged between the first motor 2 and the electric storage device B; to a drive torque or regenerative torque of the first motor 2 to shift the operating mode, is reduced smaller than the second ratio.

According to the example shown in FIG. 10, the electric power possible to be supplied to or regenerated by the first motor 2 is calculated based on an electric power supplied to or generated by the second motor 3, and calculated value is employed as the guard value of the electric power to be supplied to or regenerated by the first motor 2. According to the example shown in FIG. 10, therefore, the output torque of the second motor 3 will not be restricted, and the input power or output power to/from the electric storage device B will not exceed the maximum output power Wout, during the shifting operation from the disconnecting mode.

According to the exemplary embodiment of the present disclosure, specifically, the torque of the first motor 2 is controlled in line with a predetermined change rate of a speed of the first motor 2 so as to restrict the electric power supplied to or generated by the first motor 2 during the shifting operation from the disconnecting mode. Instead, the electric power supplied to or generated by the first motor 2 may also be restricted by restricting a change rate of a speed of the first motor 2.

Although the above exemplary embodiment of the present disclosure has been described, it will be understood by those skilled in the art that the present disclosure should not be limited to the described exemplary embodiments, and various changes and modifications can be made within the scope of the present disclosure. For example, in order not to charge the electric storage device B excessively, and in order not to discharge the electric power from the electric storage device B excessively, the output power of the second motor 3 may also be restricted in such a manner as to reduce the above-mentioned second ratio to 90%. In this case, the above-mentioned first ratio will be reduced e.g., to 80% so that the second motor 3 may be operated on the priority basis to achieve a required drive power or brake power.

In addition, any one of the first clutch CL1 and the second clutch CL2 and the engine 1 may be omitted. For example, the control system according to the exemplary embodiment of the present disclosure may be applied to an electric vehicle comprising a first motor, a second motor connected to an output side of the first motor through a clutch, and a pair of drive wheels connected to the second motor. In the electric vehicle of this kind, the first motor is operated as a motor to reduce a speed difference in the clutch when shifting an operating mode from: a mode in which the electric vehicle is powered only by the second motor while disengaging the clutch; to a mode in which the electric vehicle is powered by both of the first motor and the second motor while engaging the clutch. In a case of applying the control system according to the exemplary embodiment of the present disclosure to the electric vehicle of this kind, therefore, a required drive force may be achieved certainly by supplying an electric power from a battery to the second motor on a priority basis.

Further, in the power split mechanism 6 the ring gear 10 may be connected to the carrier 18. In this case, the sun gear 15 is selectively connected to the carrier 12 through the first clutch CL1, and any two of the sun gear 15, the carrier 18, and the ring gear 16 are connected to each other through the second clutch CL2. In a vehicle having the power split mechanism of this kind, the HV-High mode is established by engaging the first clutch CL1, and the HV-Low mode is established by engaging the second clutch CL2.

In brief, the control system is applied to the hybrid vehicle comprising the engine, the first motor, the output member, two differential mechanisms, and two clutches. In the hybrid vehicle of this kind, a split ratio of the torque delivered from the engine to the output member may be changed by manipulating the clutches. Specifically, the hybrid vehicle to which the control system according to the exemplary embodiment of the present disclosure comprises: an engine; a first motor; a pair of drive wheels; a first differential mechanism that performs a differential action among (i) a first rotary element connected to any one of the engine, the first motor, and the drive wheels, (ii) a second rotary element connected to another one of the engine, the first motor, and the drive wheels, and (iii) a third rotary element; a second differential mechanism that performs a differential action among (i) a fourth rotary element connected to still another one of the engine, the first motor, and the drive wheels, (ii) a fifth rotary element connected to the third rotary element, and (iii) a sixth rotary element; a first engagement device that selectively connects any one of a first pair of the rotary elements including the first rotary element or the second rotary element and the sixth rotary element, and a second pair of the rotary elements including any two of the fourth to sixth rotary elements; and a second engagement device that selectively connects other one of the first pair and the second pair of the rotary elements. In the hybrid vehicle of this kind, an operating mode may be selected from a low mode established by engaging the first engagement device, and a high mode established by engaging the second engagement device.

Furthermore, the control system according to the exemplary embodiment of the present disclosure may also be applied to a vehicle in which torques of the engine and the first motor are delivered to the front wheels, and a torque of the second motor is delivered to the rear wheel.

What is claimed is:

1. A vehicle control system that is applied to a vehicle comprising:
a first motor;
an engagement device that selectively interrupt torque transmission between the first motor and a pair of drive wheels;
a second motor that is connected to the pair of drive wheels or another pair of drive wheels; and
an electric storage device that is electrically connected with the first motor and the second motor,
wherein an operating mode is shifted from a first mode to a second mode while disengaging the engagement device to interrupt the torque transmission between the first motor and the pair of drive wheels, and while changing a speed of the first motor,
the control system comprising a controller that controls the first motor and the second motor,
a first ratio is defined as a ratio of: an electric power exchanged between the first motor and the electric storage device; to a power of the first motor to shift the operating mode,
a second ratio is defined as a ratio of: an electric power exchanged between the second motor and the electric storage device; to a power of the second motor to achieve a required power to drive or decelerate the vehicle, and
the controller is configured to reduce the first ratio smaller than the second ratio when a condition to shift the operating mode from the first mode to the second mode is satisfied.

2. The vehicle control system as claimed in claim 1, wherein the controller is further configured to reduce the first ratio smaller than the second ratio by restricting an output power of the first motor or an electric power regenerated by the first motor.

3. The vehicle control system as claimed in claim 2, wherein the controller is further configured to calculate a guard value of the output power of the first motor or the electric power regenerated by the first motor, by subtracting the electric power exchanged between the second motor and the electric storage device to achieve the required power from a maximum output power or maximum input power of the electric storage device.

4. The vehicle control system as claimed in claim 1, wherein the controller is further configured to reduce the first ratio smaller than the second ratio by restricting a drive torque or regenerative torque of the first motor.

5. The vehicle control system as claimed in claim 4, wherein the controller is further configured to calculate a guard value of the drive torque or regenerative torque of the first motor, by calculating an available input power or output power of the electric storage device by subtracting the electric power exchanged between the second motor and the electric storage device to achieve the required power from a maximum output power or maximum input power of the electric storage device, and dividing the available input power or output power of the electric storage device by a speed of the first motor.

6. The vehicle control system as claimed in claim 1, wherein the engagement device includes:
a first engagement device that is engaged by connecting a predetermined pair of rotary members to establish a low mode in which a torque of the engine delivered to the pair of the drive wheels is multiplied by a relatively larger factor; and
a second clutch that is engaged by connecting another pair of rotary members to establish a high mode in which the torque of the engine delivered to the pair of the drive wheels is multiplied by a factor smaller than the factor of the low mode.

7. The vehicle control system as claimed in claim 6,
wherein the vehicle further comprises
a first differential mechanism that performs a differential action among: a first rotary element connected to any one of the engine, the motor, and the pair of the drive wheels; a second rotary element connected to another one of the engine, the motor, and the pair of the drive wheels; and a third rotary element, and
a second differential mechanism that performs a differential action among: a fourth rotary element connected to the other one of the engine, the motor, and the pair of the drive wheels; a fifth rotary element connected to the third rotary element; and a sixth rotary element,
the first engagement device selectively connects any one of a first pair of the rotary elements including the first rotary element or the second rotary element and the sixth rotary element, and a second pair of the rotary elements including any two of the fourth to sixth rotary elements, and
the second engagement device selectively connects the other one of the first pair and the second pair of the rotary elements.
